(19) United States
(12) Patent Application Publication
(10) Pub. No.: US 2009/0173609 A1
(43) Pub. Date: Jul. 9, 2009

(54) PROCESS FOR KEYCAPS CAPABLE OF GUIDING LIGHT LATERALLY

(76) Inventors: Chang-Li LIU, Gueishan (TW); Che-Tung Wu, Gueishan (TW)

Correspondence Address: HDLS Patent & Trademark Services, P.O. BOX 220746, CHANTILLY, VA, 20153-0746, US

(21) Appl. No.: 12/128,068

(22) Filed: May 28, 2008

(30) Foreign Application Priority Data
Jan. 9, 2008 (TW) 097100773

(51) Int. Cl. H01H 9/00

(52) U.S. Cl. 200/314

(57) ABSTRACT

A process for keycaps includes the steps of: providing a light-transmitting material; making the light-transmitting material into a keycap body, the keycap body having a light-entering surface, one side of the light-entering surface extending to form a light-exiting surface intersecting with the light-entering surface, a connecting surface being formed between the light-entering surface and the light-exiting surface; and coating a light-shielding layer on the connecting surface to form a light-reflecting surface in the light-shielding layer. Via the above process, a keycap that guides light laterally can be obtained.

### RELATED APPLICATION

U.S. patent application Ser. No. 11/947,821 filed on Nov. 30, 2007 is submitted as related application.

### BACKGROUND OF THE INVENTION

1. Field of the Invention

The present invention relates to a method for manufacturing keys, and in particular to a process for keycaps capable of guiding light laterally.

2. Description of Prior Art

A keyboard is one of the primary input means for an electronic device. The surface of each key of the keyboard is provided with corresponding numerals, characters, phonetic symbols, roots for an input method and/or various functional icons, so that a user can input correct data or perform various functions of the electronic device. Therefore, for an electronic device, the keyboard acts as an important human/machine interface.

Since the light may be sometimes insufficient for a working environment of an electronic device, the key panel of the keyboard is usually provided with a light source to generate a little or sufficient light for recognition, so that the user can still operate the key panel even though the light is dim. Although the displaying area can be illuminated directly via an underneath light source so as to generate a better illumination effect, the direct illumination may be harsh to the user's eyes. Especially in a dark environment, a light emitted suddenly may be so harsh to the user's eyes if he/she looks at the light, which will affect the vision of the user temporarily. According to the above, in order to overcome the drawbacks of prior art, the inventor proposes the present invention based on his researches and expert experience.

### SUMMARY OF THE INVENTION

The present invention is to provide a process for keycaps capable of guiding light laterally, by which a keycap can be manufactured to provide a lateral light for a key without making the light to irradiate the user's eyes directly. In this way, the hurt to the user's eyes can be reduced or eliminated.

The present invention provides a process for keycaps capable of guiding light laterally, which includes the steps of:

a) providing a light-transmitting material;

b) making the light-transmitting material into a keycap body, the keycap body having a light-entering surface, one side of the light-entering surface extending to form a light-exiting surface intersecting with the light-entering surface, and a connecting surface being formed between the light-entering surface and the light-exiting surface; and

c) coating a light-shielding layer on the connecting surface to form a light-reflecting surface in the light-shielding layer.

Via the above process, a keycap that guides light laterally can be obtained.

### BRIEF DESCRIPTION OF THE DRAWINGS

FIG. 1 is an exploded perspective view showing a key panel to which the keycaps of the present invention are applied;

FIG. 2 is an assembled perspective view of FIG. 1;

FIG. 3 is an enlarged cross-sectional view taken along the line 3-3 in FIG. 2;

FIG. 4 is flow chart showing the process of the present invention;

FIG. 5 is a plan view showing the state after the keycap body of the present invention is formed;

FIG. 6 is a plan view showing the state after the keycap body of the present invention is covered by a light-shielding layer;

FIG. 7 is a partially cross-sectional view showing the state after the key panel of FIG. 3 is assembled with a telecommunication module;

FIG. 8 is a schematic view showing the action of FIG. 7;

FIG. 9 is a schematic view showing the key panel having the keycaps of the present invention being used in a mobile phone;

FIG. 10 is a schematic view showing the key panel having the keycaps of the present invention being used in a personal digital assistant; and

FIG. 11 is a schematic view showing the key panel having the keycaps of the present invention being used in an automobile control interface.

### DETAILED DESCRIPTION OF THE INVENTION

In order to make the Examiner to better understand the characteristics and technical contents of the present invention, a detailed description relating thereto will be made with reference to the accompanying drawings. However, the drawings are illustrative only, but not used to limit the scope of the present invention.

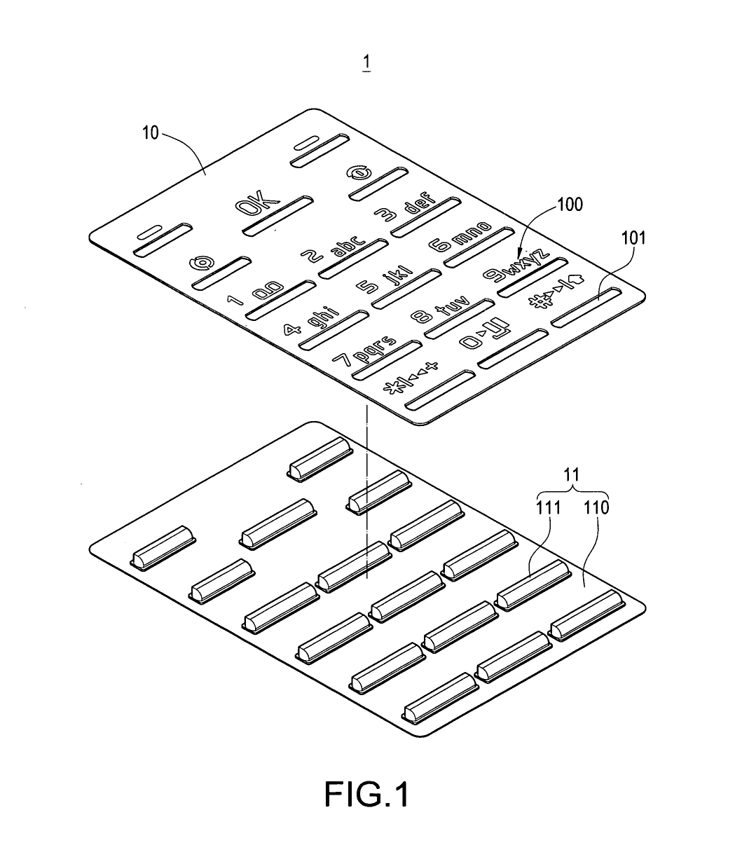

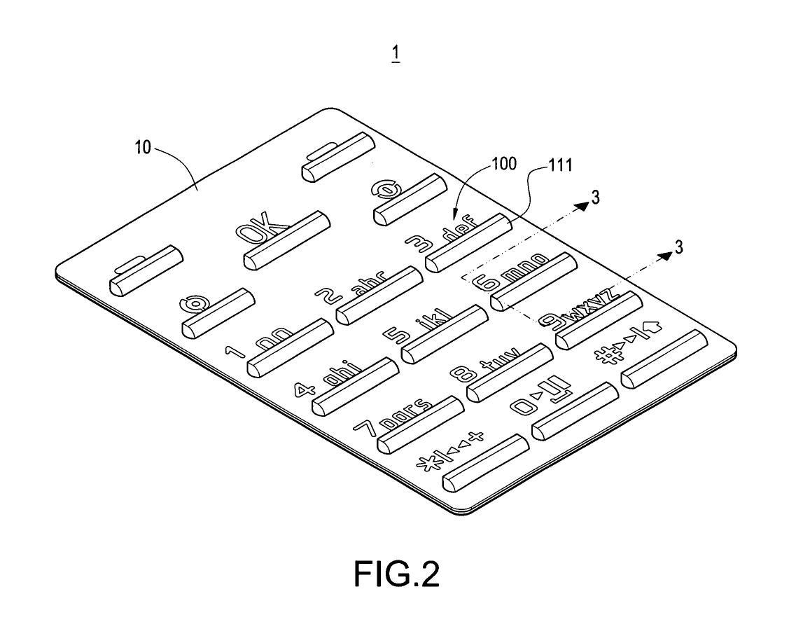

The present invention provides a process for keycaps capable of guiding light laterally. Keycaps 111 manufactured according to this process can be applied to a key panel 1. As shown in FIGS. 1 and 2, the key panel 1 includes an opaque layer 10 and a keycap assembly 11.

The opaque layer 10 is a thin sheet made of an opaque material such as a circuit board, electronic ink, wood, cork, leather, metal or the like. Via a printing, etching or an electronic ink developing process, an upper surface of the opaque layer 10 is provided with recognition regions 100 constituted of numerals, characters, phonetic symbols, roots for an input method and/or various functional icons. A corresponding keycap hole 101 is provided adjacent to one side of each recognition region 100 on the opaque layer 10. In the illustrated embodiment of the present invention, when the opaque layer 10 is in an upright position, each of the keycap holes 101 is located below the corresponding recognition region 100. Of course, the possible arrangement is not limited thereto.

The keycap assembly 11 is located on a lower surface of the opaque layer 10. The keycap assembly 11 has a carrier 110 that is overlapped in parallel with the surface of the opaque layer 10, and a plurality of keycaps 111 protruding from the carrier 110. Each of the keycaps 111 is arranged to correspond to an associated recognition region 100, and penetrates through the corresponding keycap hole 101 to protrude from the surface of the opaque layer 10, so that a user can press the keycap.

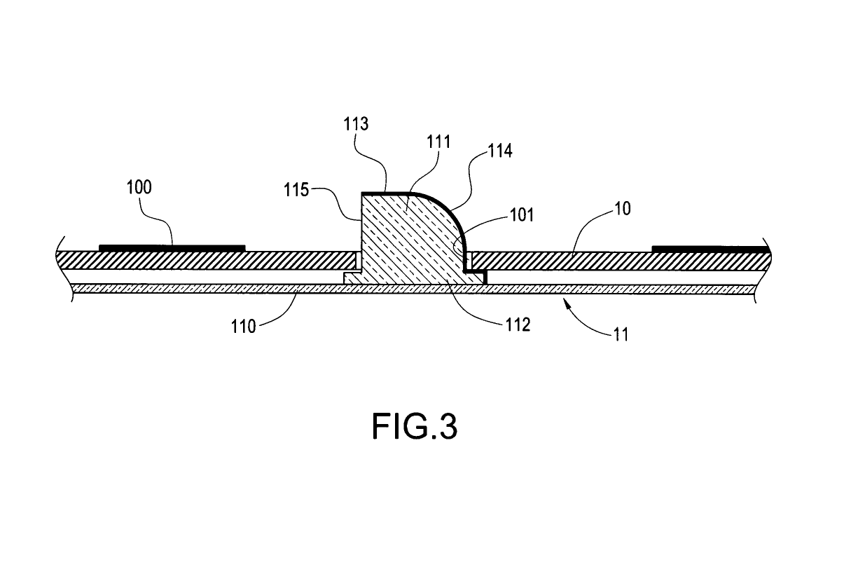

As shown in FIG. 3, each keycap 111 is made of a light-transmitting material, such as acryl, plastic or PC, and can be colored as desired. Each keycap 111 has a light-entering surface 112 that is located in the bottom thereof and adhered on the carrier 110. The top of each keycap 111 has a light-shielding layer 113. The light-shielding layer 113 can be attached to the surface of the keycap 111 via an electroplating process. Further, the light-shielding layer 113 covers each lateral outer surface from the top of the keycap 111. A connecting surface 114 is formed between the top of the keycap 111 and a lateral surface. A light-exiting surface 115 is formed on one side of the keycap 111 opposite to the connecting surface 114. The light-exiting surface 115 is not covered by the light-shielding layer 113, and thus it cannot shield the light. After the keycap 111 penetrates through the corresponding keycap hole 101, the light-exiting surface 115 of the keycap 111 corresponds to an associated recognition region 100, thereby projecting the light onto the recognition region 100. The process for manufacturing the keycap 111 is described as follows.

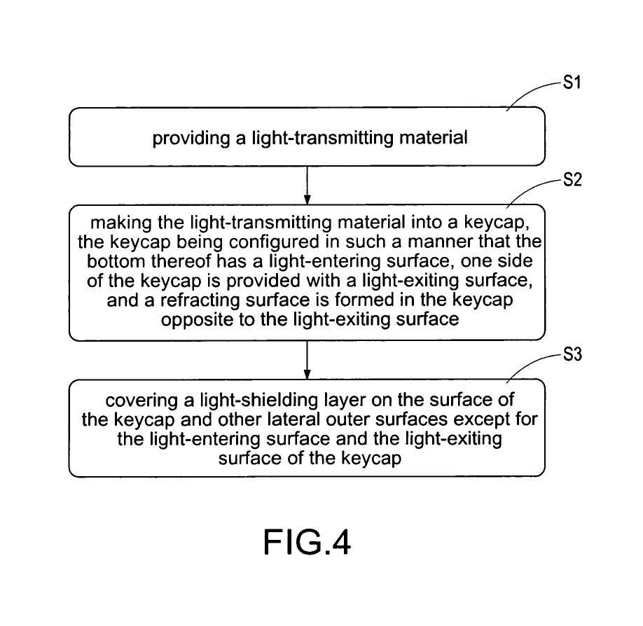

Please refer to FIG. 4. In the step S 1, a light-transmitting material is provided first, which is used as the necessary material for the keycap 111.

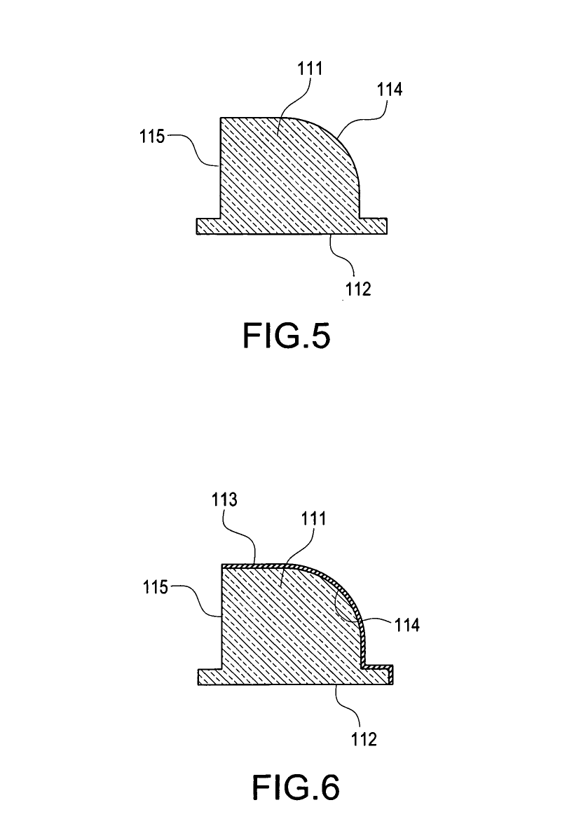

Then, please refer to FIGS. 4 and 5. According to the step S2 in FIG. 4, the light-transmitting material is formed to have the profile of the keycap 111 (i.e. keycap body) that has the light-entering surface 112. One side of the light-entering surface 112 extends to form the light-exiting surface 115 intersecting with the light-entering surface 112. The connecting surface 114 is formed between the light-exiting surface 115 and the light-entering surface 112.

Finally, please refer to FIGS. 4 and 6. According to the step S3 in FIG. 4, except for the light-entering surface 112 and the light-exiting surface 115, the connecting surface 114 of the keycap body is coated by the light-shielding layer 113, thereby forming a light-reflecting surface in the light-shielding layer 113. In this way, the keycap 111 can be obtained.

Therefore, the above steps are those of the process for a keycap guiding light laterally in accordance with the present invention.

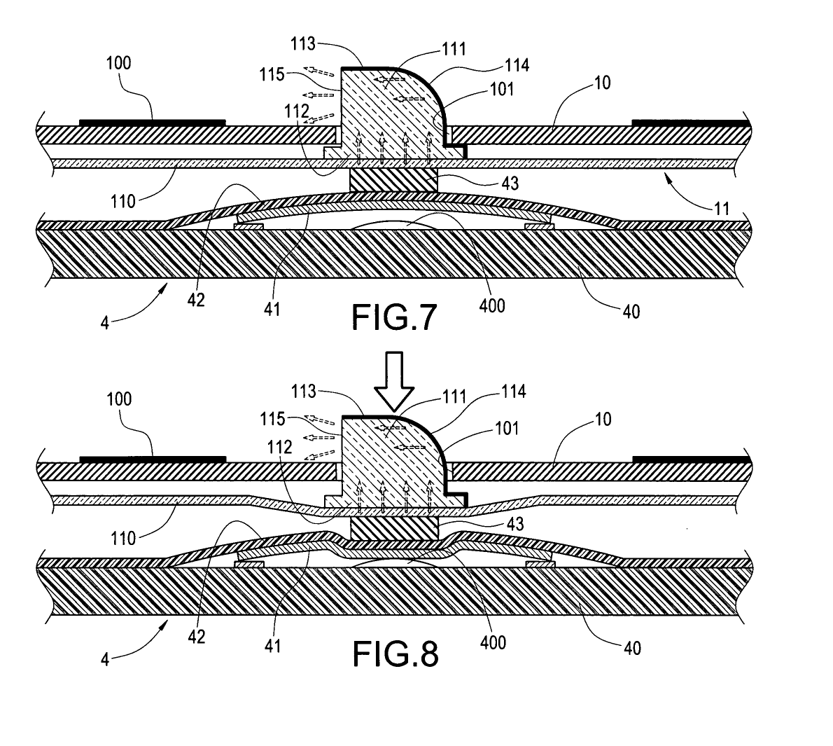

Please refer to FIG. 7, when the keycap 111 is applied to the key panel 1, the underside of the key panel 1 can be further assembled with a telecommunication module 4. The telecommunication module 4 has a flexible printed circuit board 40. The circuit board 40 is provided thereon with a plurality of contacting points 400. Each of the contacting points 400 corresponds to each keycap 111 of the key module in a vertical direction. Each of the contacting points 400 is provided thereon with a corresponding metal sheet 41. The circuit board 40 is provided thereon with an elastic film 42 for covering each metal sheet 41. A plurality of protrusions 43 is provided between the elastic film 42 and the key module. Each protrusion 43 is located to correspond to the underside of each keycap 111 of the key module.

Please refer to FIG. 8. When the user applies a downward force to press any keycap 111, the corresponding protrusion 43 is pressed to bias downwardly the elastic film 42 and the metal sheet 41 so as to touch the corresponding contacting point 400, thereby achieving an input action. At this time, via the pressing action of the user, the light emitted from a built-in light source is introduced from the light-entering surface 112 of the keycap 111. After being reflected by the light-reflecting surface of the light-shielding layer 113, the light is projected toward the light-exiting surface 115 and onto the recognition region 100, thereby illuminating the recognition region 100. In this way, the user can recognize the completion of the pressing action, and the light will not irradiate the user's eyes directly to affect his/her vision.

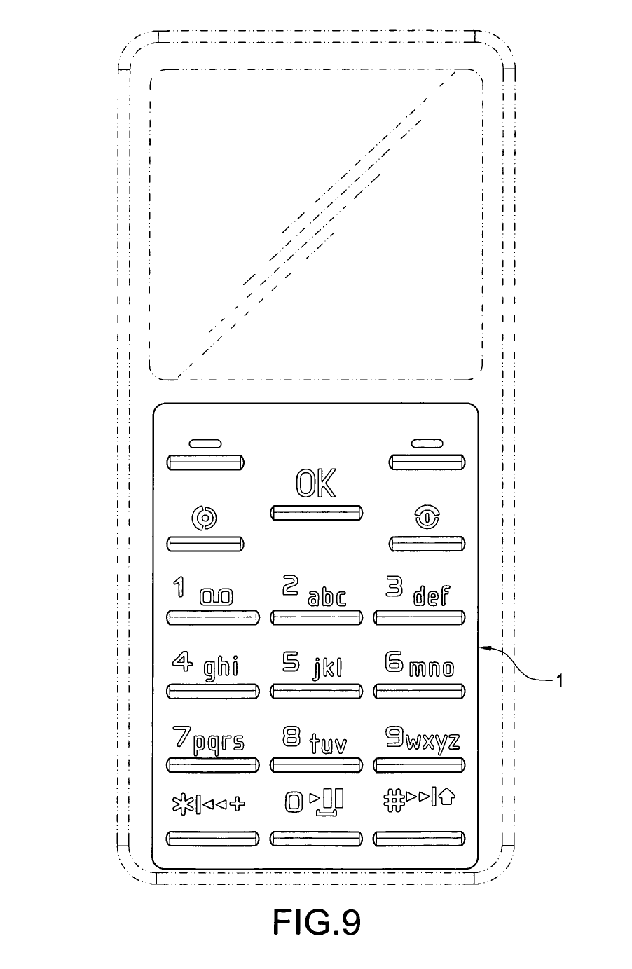

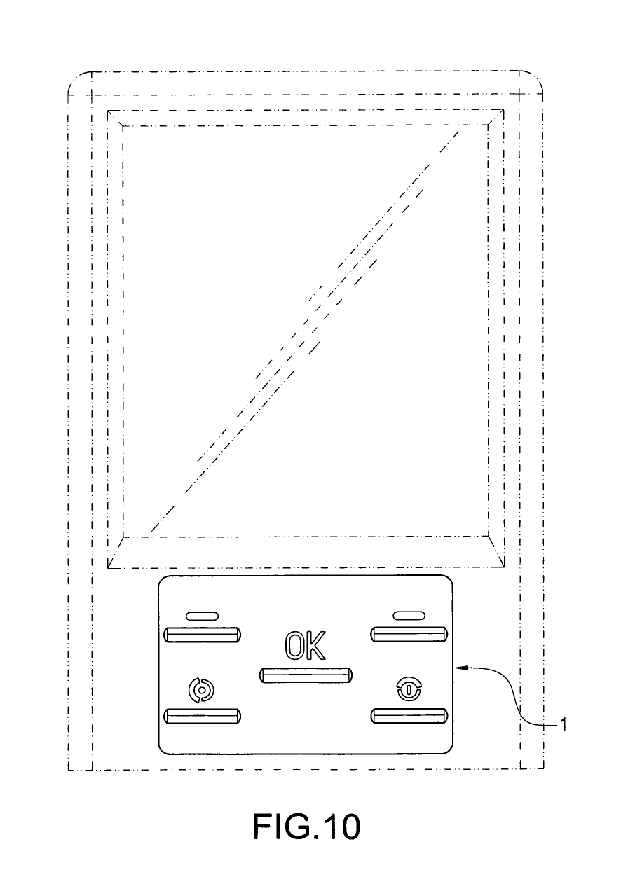

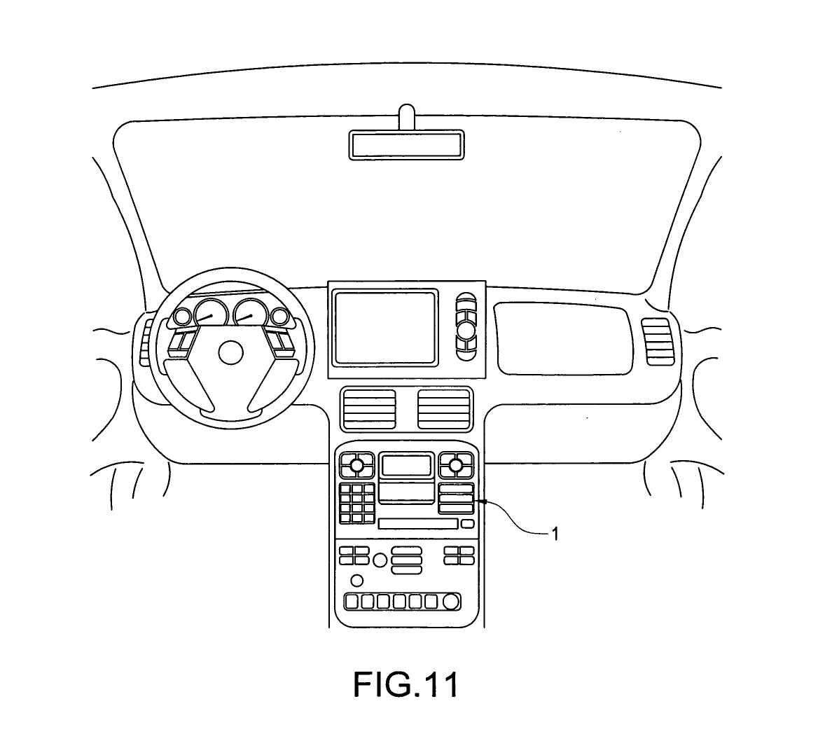

Further, please refer to FIGS. 9 to 11. The keycaps 111 manufactured according to the process of the present invention can be applied to the key panel 1. Thereafter, the key panel having the keycaps of the present invention can be applied at least to a mobile phone, a personal digital assistant (PDA) and an automobile control interface. Of course, the application is not limited to the above cases, and the present invention can be applied to other human/machine operating interfaces.

According to the above, the present invention really achieves the desired objects and solves the drawbacks of prior art. Further, the present invention has novelty and inventive steps, and thus conforms to the requirements for an invention patent.

Although the present invention has been described with reference to the foregoing preferred embodiments, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A process for keycaps capable of guiding light laterally, comprising the steps of:
a) providing a light-transmitting material;
b) making the light-transmitting material into a keycap body, the keycap body having a light-entering surface, one side of the light-entering surface extending to form a light-exiting surface intersecting with the light-entering surface, a connecting surface being formed between the light-entering surface and the light-exiting surface; and
c) coating a light-shielding layer on the connecting surface to form a light-reflecting surface in the light-shielding layer.

2. The process for keycaps guiding light laterally according to claim 1, wherein the light-transmitting material provided in the step a) is acryl.

3. The process for keycaps guiding light laterally according to claim 1, wherein the light-transmitting material provided in the step a) is plastic.

4. The process for keycaps guiding light laterally according to claim 1, wherein the light-transmitting material provided in the step a) is PC.

5. The process for keycaps guiding light laterally according to claim 2, wherein the light-transmitting material provided in the step a) is colored.

6. The process for keycaps guiding light laterally according to claim 1, wherein the light-shielding layer mentioned in the step c) is coated on the connecting surface of the keycap body via an electroplating process.
